(19) United States
(12) Patent Application Publication
(10) Pub. No.: US 2013/0077516 A1
(43) Pub. Date: Mar. 28, 2013

(54) RADIO COMMUNICATION APPARATUS, RADIO COMMUNICATION METHOD, AND RADIO COMMUNICATION SYSTEM

(71) Applicant: FUJITSU LIMITED, Kawasaki-shi (JP)

(72) Inventor: Masahiro Watanabe, Tachikawa (JP)

(21) Appl. No.: 13/626,945

(22) Filed: Sep. 26, 2012

(30) Foreign Application Priority Data
Sep. 28, 2011 (JP) 2011-211753

(51) Int. Cl. H04W 24/00

(52) U.S. Cl. 370/252

(57) ABSTRACT

In a radio communication apparatus, a packet size estimation unit estimates the packet size of a packet transmitted to the radio communication apparatus from a transmission side. A reception quality measurement unit measures reception quality of a received signal to obtain a reception quality measurement value. A code block number estimation unit estimates the numbers of code blocks in one packet using the packet size and the code block sizes for individual operation modes. An operation mode selection control unit recognizes desired qualities with respect to the individual operation modes from the estimated numbers of code blocks. Then, the operation mode selection control unit selects an appropriate operation mode based on a result of comparing the desired qualities with the reception quality measurement value.

### CROSS-REFERENCE TO RELATED APPLICATION

This application is based upon and claims the benefit of priority of the prior Japanese Patent Application No. 2011-211753, filed on Sep. 28, 2011, the entire contents of which are incorporated herein by reference.

### FIELD

The embodiment discussed herein relates to a radio communication apparatus, a radio communication method, and a radio communication system.

### BACKGROUND

In recent years, radio communication is performed in a communication operation mode selected according to propagation environment. Examples of operation modes to be selected include a modulation and coding scheme (MCS, a combination of a modulation method and a coding rate) mode, a multiple input multiple output (MIMO) mode, and the like.

Meanwhile, in radio communications, bit errors are caused on a receiver side by noise, interference, and fading fluctuations in propagation paths. To reduce effects of bit errors, a transmitter side codes and then transmits data.

For example, data to be transmitted is coded on the transmitter side using a forward error correction (FEC) coding or the like, to form an FEC code block. Then, one or a plurality of FEC code blocks are regarded as a unit, a cyclic redundancy check (CRC) code for error detection is added to the unit, and transmitted. The resultant data unit that is formed by adding the CRC code to one or a plurality of FEC code blocks is called a “packet”.

Then, a receiver receives the packets and demodulates the FEC code blocks. This contributes to reducing a bit error rate. Furthermore, the receiver is able to detect an error that has not been corrected when the FEC code blocks were decoded, based on the CRC code.

When some error is detected in a packet, the packet is entirely discarded or the receiver sends a retransmission request to the transmitter so that the packet is retransmitted. A packet error rate thus affects the throughput.

For this reason, in order to realize high throughput, the receiver selects an operation mode so that a packet error rate does not exceed a predetermined value (for example, 10%).

There has been proposed a technique to adaptively select a modulation method while updating the correspondence relationship between a communication quality and a combination of a modulation method and an error correction coding rate.

See, for example, Japanese Laid-open Patent Publication No. 2010-74365.

Generally, a packet error rate varies depending on the number of FEC code blocks contained in one packet. Therefore, in order to select an operation mode so that a packet error rate does not exceed a predetermined value, it is important to select an operation mode based on appropriate estimation of the number of FEC code blocks contained in a packet.

However, conventional receivers do not appropriately estimate the number of FEC code blocks in a packet. Thus, an operation mode is not selected based on an appropriately estimated number of FEC code blocks.

Thus, in conventional radio communications, there may be a case that radio communication is established with inappropriate operation mode being selected. As a result, a packet error rate exceeds a predetermined value, so that the throughput deteriorates.

### SUMMARY

According to one aspect, there is provided a radio communication apparatus that includes: a packet size estimation unit configured to estimate a packet size of a packet transmitted to the radio communication apparatus; a reception quality measurement unit configured to perform reception quality measurement of a received signal to obtain a reception quality measurement value; a code block number estimation unit configured to estimate numbers of code blocks contained in the packet using the packet size and code block sizes for individual operation modes; and an operation mode selection control unit configured to recognize desired qualities for the individual operation modes based on the estimated numbers of code blocks, and select an operation mode based on a result of comparing the desired qualities with the reception quality measurement value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a radio communication apparatus;

FIG. 2 illustrates a configuration example of a radio communication apparatus;

FIG. 3 illustrates a configuration example of MAP information;

FIG. 4 illustrates a table indicating a correspondence relationship between an MCS and an FEC code block size;

FIG. 5 illustrates a threshold information table;

FIG. 6 illustrates a threshold information table;

FIG. 7 illustrates a logarithmic approximation graph;

FIG. 8 illustrates a configuration example of a radio communication apparatus;

FIG. 9 illustrates a configuration example of a radio communication apparatus;

FIG. 10 illustrates an operation flow;

FIG. 11 illustrates a configuration example of a radio communication apparatus;

FIGS. 12 and 13 illustrate an operation flow;

FIG. 14 illustrates a hardware configuration example of a radio communication apparatus;

FIG. 15 illustrates a configuration example of a radio communication system; and

FIG. 16 illustrates a hardware configuration example of a radio base station.

### DESCRIPTION OF EMBODIMENTS

Several embodiments will be described below with reference to the accompanying drawings, wherein like reference numerals refer to like elements throughout.

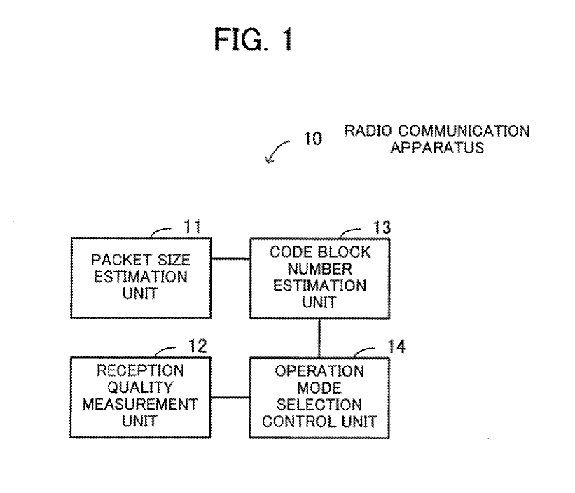

FIG. 1 illustrates a configuration example of a radio communication apparatus. The radio communication apparatus 10 includes a packet size estimation unit 11, a reception quality measurement unit 12, a code block number estimation unit 13, and an operation mode selection control unit 14. The radio communication apparatus 10 is, for example, a mobile device such as a mobile phone.

The packet size estimation unit 11 estimates a packet size of a packet transmitted to the radio communication apparatus 10 from a transmission side. The reception quality measurement unit 12 measures a reception quality of a received signal to obtain a reception quality measurement value.

The code block number estimation unit 13 estimates the numbers of code blocks contained in one packet through calculation based on the estimated packet size and the code block sizes for individual operation modes. The operation mode selection control unit 14 recognizes desired qualities with respect to the individual operation modes based on the estimated numbers of code blocks. Then, the operation mode selection control unit 14 compares the desired qualities with the reception quality measurement value, and selects an appropriate operation mode based on the comparison result.

Specifically, when the reception quality measurement value is equal to or greater than a certain desired quality, the operation mode associated with this desired quality is determined to be applicable. When the reception quality measurement value is less than a certain desired quality, the operation mode associated with this desired quality is determined to be not applicable.

As described above, the radio communication apparatus 10 is configured to estimate the numbers of code blocks contained in a packet based on an estimated packet size and the code block sizes of individual operation modes. The radio communication apparatus 10 then recognizes desired qualities with respect to the individual operation modes based on the estimated numbers of code blocks, and based on the results of comparing the desired qualities with the reception quality measurement value, selects an appropriate operation mode.

The above approach makes it possible to properly estimate the number of code blocks, and in turn to select an optimum operation mode based on the estimation result. Furthermore, since radio communication is established with an optimum operation mode suitable for a propagation environment being selected, deterioration of throughput is suppressed.

Next, operations of the radio communication apparatus 10 will be described in detail with specific examples. In this embodiment, forward error correction (FEC) coding is used as a coding scheme to be applied to a packet on the transmission side. Hereinafter, a code block is referred to as “FEC code block”.

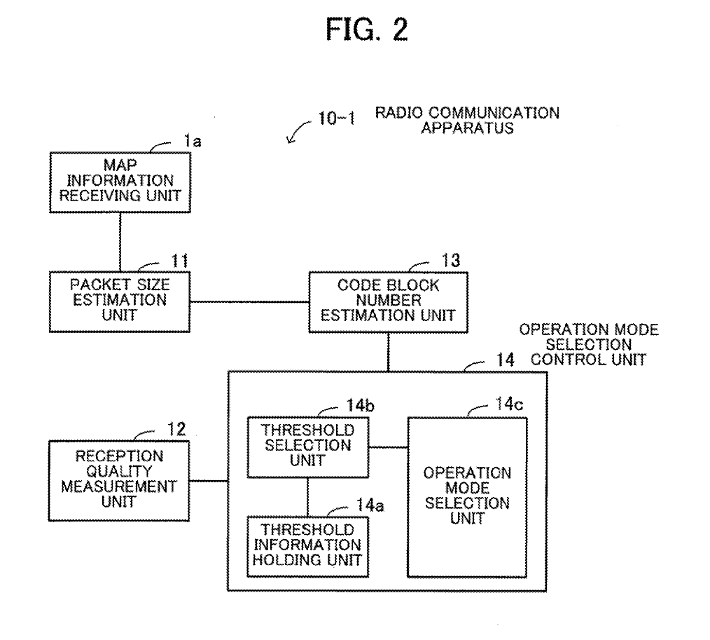

FIG. 2 illustrates a configuration example of the radio communication apparatus. A radio communication apparatus 10-1 includes a packet size estimation unit 11, a reception quality measurement unit 12, a code block number estimation unit 13, an operation mode selection control unit 14, and an MAP information receiving unit 1a. The operation mode selection control unit 14 includes a threshold information holding unit 14a, a threshold selection unit 14b, and an operation mode selection unit 14c.

The MAP information receiving unit 1a receives and analyzes MAP information transmitted from a transmitting station such as a radio base station or the like. The MAP information is control information including packet allocation information, modulation and coding information, MIMO mode information and the like of a radio frame transmitted from the radio base station.

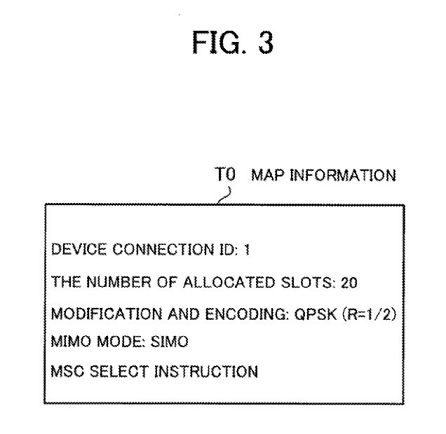

FIG. 3 illustrates a configuration example of the MAP information. Attributes of the MAP information TO include, for example, a device connection ID (identifier), the number of allocated slots, a modulation and coding scheme, and a MIMO mode. In the example illustrated in FIG. 3, the device connection ID is 1 (i.e., the ID for the radio communication apparatus 10-1 is 1), the number of allocated slots is 20, the modulation and coding scheme is QPSK (Quadrature phase shift keying: R=1/2), and the MIMO mode is the single-input, multiple-output (SIMO) mode.

In FIG. 3, the indication “MCS Select Instruction” is a message for a radio base station to instruct the radio communication apparatus 10-1 to select an MCS.

The packet size estimation unit 11 estimates a packet size by averaging packet allocation information (the number of allocated slots) described in currently received MAP information TO and past packet allocation information.

As used herein, the term “size” refers to an amount of radio resources to be used. For example, according to the Mobile WiMAX (Worldwide Interoperability for Microwave Access), the size of a packet is represented by the number of slots in units of 48 which is calculated by multiplying the number of subcarriers to be used by the number of symbols.

In the MAP information T0 of this example, the number of allocated slots to the current packet is 20. Here, assume that the numbers of allocated slots to past packets are 10, 10, 30, and 30, and consider to determine the packet size by averaging the numbers of allocated slots to these five packets. In this case, since the average value is 20 (=(10+10+30+30+20)/5), the packet size is estimated as 20.

The reception quality measurement unit 12 receives preamble signals and pilot signals from a radio base station, and measures a reception quality represented by a carrier to interference and noise ratio (CINR) or the like. In this example, it is assumed that the reception quality measurement value (CINR value) is 12 dB.

The code block number estimation unit 13 calculates the numbers of code blocks with respect to the individual operation modes based on the packet size estimation result and the code block size.

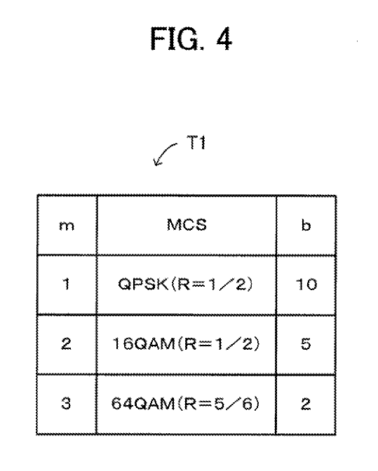

FIG. 4 illustrates a table indicating a correspondence relationship between the MCS and the FEC code block size. The table T1 is under the control of the code block number estimation unit 13. Listed in the table T1 are m (operation mode), MCS, and b (FEC code block size).

In the example illustrated in FIG. 4, the FEC code block size is that for the SIMO mode. In the operation mode m=1, the MCS is QPSK (R=1/2), and the FEC code block size is b=10.

In the operation mode m=2, the MCS is 16QAM (Quadrature Amplitude Modulation: R=1/2), and the FEC code block size is b=5. Furthermore, the operation mode m=3, the MCS is 64QAM (R=5/6), and the FEC code block size is b=2.

Here, it is assumed that the FEC code block size that is used for the operation mode m is b(m), and an estimated value (average value) of an allocated packet size is A. When the operation mode m is used, the number of FEC code blocks X(m) contained in one packet can be estimated by calculation using the following equation (1):

X(m)=ceil(A/b(m)) (1),

where ceil(x) represents a ceiling function that gives the least integer greater than or equal to a real number x. For example, the base e of the natural logarithm is e=2.718 . . . . Thus, the ceiling function of e is represented by: ceil(e)=3.

The code block number estimation unit 13 calculates the numbers of FEC code blocks X(1) to X(3) for one packet with respect to the individual operation modes m=1, m=2, and m=3. In this example, in the operation mode m=1, the number of FEC code blocks X(1) is given by: X(1)=20/10=2.

In the operation mode m=2, the number of FEC code blocks X(2) is given by: X(2)=20/5=4. Furthermore, in the operation mode m=3, the number of FEC code blocks X(3) is given by: X(3)=20/2=10.

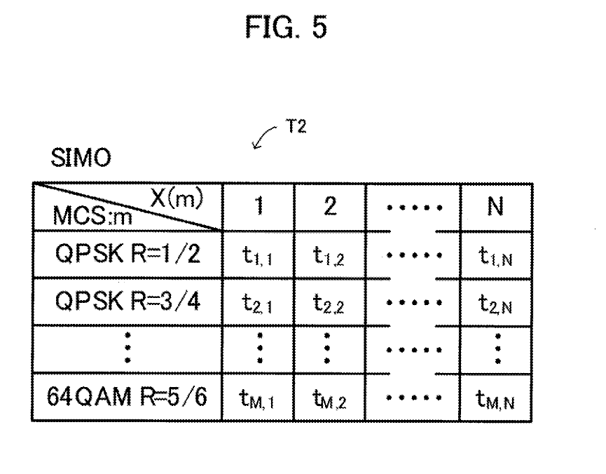

The threshold information holding unit 14a holds the desired qualities for the individual operation modes. Since the desired qualities are used as thresholds, they are hereinafter referred to as “desired quality thresholds”. FIG. 5 illustrates a threshold information table T2. The threshold information holding unit 14a determines the desired quality thresholds with respect to the individual operation modes in advance, as parameter values for the number of FEC code blocks, and holds them in the threshold information table T2.

FIG. 5 illustrates an example of a table used when selecting a modulation and coding scheme (MCS) in the case where an antenna structure uses SIMO as an operation mode. This table lists desired quality thresholds t_{m,n} which are used when the MCS is m and the number of FEC code blocks in one packet is n.

By providing such a threshold information table T2, the desired quality thresholds for individual operation modes can be easily determined from the number of FEC code blocks in one packet.

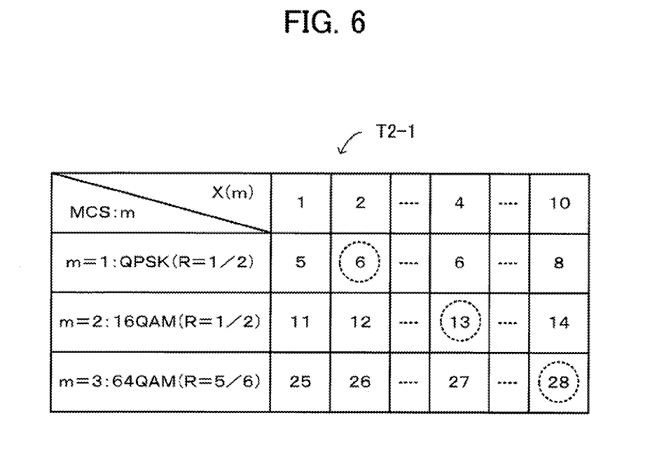

FIG. 6 illustrates another threshold information table. The threshold information table T2-1 is a specific example of the table illustrated in FIG. 5. In the table, operation modes m are listed in the column, the estimated numbers of FEC code blocks X(m) are listed in the row, and the desired quality thresholds (unit: dB) for the individual operation modes m are registered for each number of FEC code blocks (estimated number).

For example, in operation mode m=1 (QPSK(R=1/2)): the desired quality threshold is 5 when the number of FEC code blocks is 1; the desired quality threshold is 6 when the number of FEC code blocks is 2; the desired quality threshold is 6 when the number of FEC code blocks is 4; and the desired quality threshold is 8 when the number of FEC code blocks is 10.

Then, the threshold selection unit 14b selects the desired quality thresholds for individual operation modes in the threshold information table T2-1 using the corresponding estimated numbers of FEC code blocks. In this regard, in the operation mode m=1, the estimated number of FEC code blocks is 2. Thus, the desired quality threshold Th1=6 dB is selected from the threshold information table T2-1.

In the operation mode m=2, the estimated number of FEC code blocks is 4. Thus, the desired quality threshold Th2=13 dB is selected from the threshold information table T2-1. Furthermore, in the operation mode m=3, the estimated number of FEC code blocks is 10. Thus, the desired quality threshold Th3=28 dB is selected from the threshold information table T2-1.

The operation mode selection unit 14c compares the desired quality threshold Th for each operation mode and the reception quality measurement value Z, and determines whether the operation mode is applicable. Specifically, when the desired quality threshold Th for a certain operation mode is equal to or less than the reception quality measurement value Z, this operation mode is applicable. In contrast, when the desired quality threshold Th for a certain operation mode is greater than the reception quality measurement value Z, this operation mode is not applicable.

In this example, Z=12 dB, where Z is a CINR value that is a reception quality measurement value. Furthermore, in the operation mode m=1, the desired quality threshold Th1=6 dB. Therefore, the comparison results in Z≧Th1 (12 dB≧36 dB), so that the operation mode m=1 is applicable.

In the operation mode m=2, the desired quality threshold Th2=13 dB. Therefore, the comparison results in Z<Th2 (12 dB<13 dB), so that the operation mode m=2 is not applicable. In the operation mode m=3, the desired quality threshold Th3=28 dB. Therefore, the comparison results in Z<Th3 (12 dB<28 dB), the operation mode m=3 is not applicable.

Therefore, in the case of this example, the operation mode m=1 (i.e., QPSK(R=1/2)) is selected as an optimum operation mode. The selected operation mode is reported to the radio base station.

Next, the description will be given on the case of calculating the desired quality thresholds with respect to the individual operation modes using a logarithmic approximation expression of the numbers of FEC code blocks. This example uses the logarithmic approximation expression for obtaining desired quality thresholds while the information table T2 is used in the previous example described above.

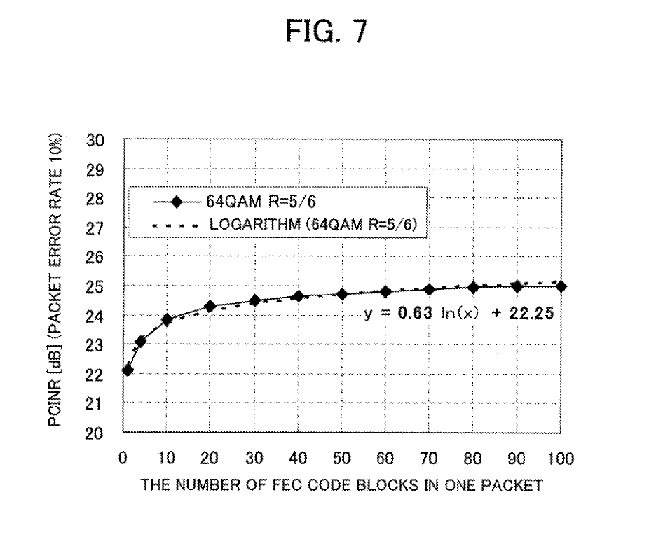

FIG. 7 illustrates a logarithmic approximation graph. In this graph, the vertical axis indicates the physical carrier to interference and noise ratio (PCINR), and the lateral axis indicates the number of FEC code blocks in one packet.

Specifically, this graph represents the logarithmic approximation expression (y=0.63×ln(x)+22.25 where ln(x)=logₑ(x)) for the desired PCINR (dB) in the case where a terminal station with a Mobile WiMAX standard minimum mean square error (MMSE) receiver uses SIMO as an antenna system operation mode and uses 64 QAM (R-5/6) for the MCS.

Using such a logarithmic approximation graph (logarithmic approximation expression), the desired quality thresholds for individual operation modes can also be easily determined from the number of FEC code blocks in one packet.

Then, the description will be given on the case of measuring the dispersion in packet size, and selecting an operation mode while changing a desired quality threshold according to the measured dispersion.

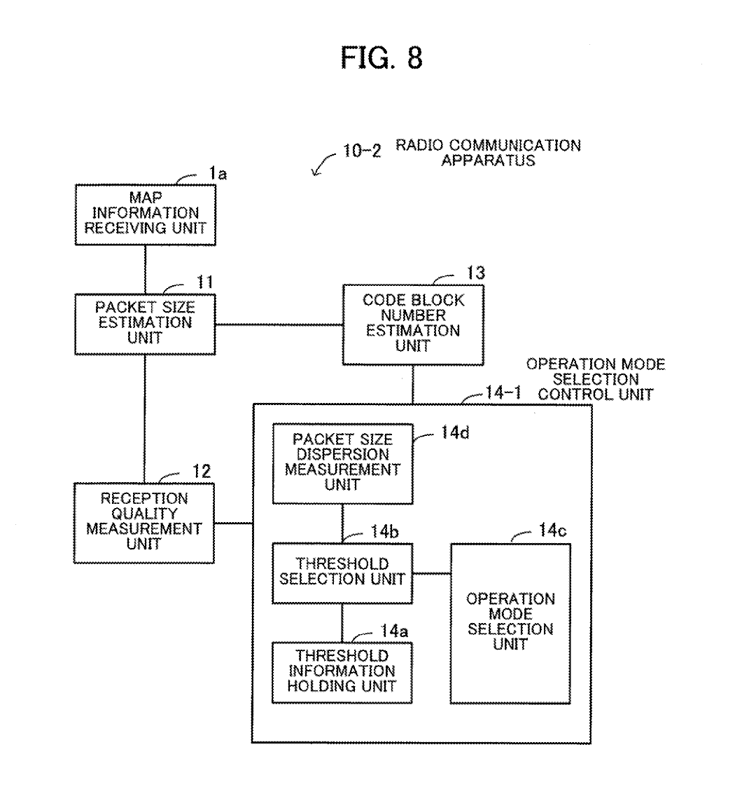

FIG. 8 illustrates a configuration example of a radio communication apparatus. The radio communication apparatus 10-2 includes a packet size estimation unit 11, a reception quality measurement unit 12, a code block number estimation unit 13, an operation mode selection control unit 14-1, and an MAP information receiving unit 1a. The operation mode selection control unit 14-1 includes a threshold information holding unit 14a, a threshold selection unit 14b, an operation mode selection unit 14c, and a packet size dispersion measurement unit 14d.

The MAP information receiving unit 1a receives and analyzes MAP information (in this example, it is assumed that this MAP information is the same as that illustrated in FIG. 3) from a radio base station.

The packet size estimation unit 11 estimates an average allocated size to one estimation-target packet based on packet allocation information (the number of allocated slots) described in currently received MAP information and past packet allocation information.

In the MAP information of this example, the number of allocated slots to the current packet is 20. Here, assume that the numbers of allocated slots to past packets are 10, 10, 30, and 30, and consider the case in which a packet size is determined by averaging the numbers of allocated slots to these five packets. In this case, the average packet size value is 20 (=(10+10+30+30+20)/5).

The packet size dispersion measurement unit 14d uses the packet allocation information to determine a variation in size allocated to one packet as the dispersion in packet size. The dispersion D is calculated using the following equation (2):

D=Σ(A−S(t))²/k (2),

where A is the average packet size, S(t) is the number of allocated slots to packet at a time t, and k is the number of packets whose dispersion is to be determined. In this example, D=80 is obtained by substituting the numerical values into Equation (2).

The reception quality measurement unit 12 receives preamble signals and pilot signals from the radio base station, and measures reception quality represented by CINR or the like. In this example, it is assumed that the reception quality measurement value (CINR value) is 28 dB.

The code block number estimation unit 13 calculates the numbers of FEC code blocks with respect to the individual operation modes based on the estimated packet size and the FEC code block sizes. Here, it is assumed that the FEC code block sizes for the individual operation modes are given by the table T1 in FIG. 4.

The numbers of FEC code blocks X(1) to X(3) for one packet are calculated with respect to the individual operation modes m=1 to m=3. In the operation mode m=1, the number of FEC code blocks x(1) is given by: X(1)=20/10=2.

In the operation mode m=2, the number of FEC code blocks X(2) is given by: X(2)=20/5=4. Furthermore, in the operation mode m=3, the number of FEC code blocks X(3) is given by: X(3)=20/2=10.

The threshold information holding unit 14a holds desired quality thresholds for individual operation modes (here, it is assumed that the thresholds held here are the same as those listed in the threshold information table T2-1 in FIG. 6). The threshold selection unit 14b selects thresholds with respect to the individual operation modes from the threshold information table T2-1 in FIG. 6 using the corresponding estimated numbers of FEC code blocks.

Here, in the operation mode m=1, the number of FEC code blocks is 2. Thus, the desired quality threshold Th1=6 dB is selected from the threshold information table T2-1. Furthermore, in the operation mode m=2, the number of FEC code blocks is 4. Thus, the desired quality threshold Th2=13 dB is selected from the threshold information table T2-1. Still furthermore, in the operation mode m=3, the number of FEC code blocks is 10. Thus, the desired quality threshold Th3=28 dB is selected from the threshold information table T2-1.

Then, the operation mode selection unit 14c calculates offset by the measured dispersion, and determines Thoffset that is a desired quality threshold for each different operation mode to which the offset is added. Then, the operation mode selection unit 14c compares the desired quality threshold Thoffset with the reception quality measurement value Z, and determines whether the relevant operation mode is applicable.

The offset (Offset) is calculated using the following equation (3):

Offset=αm×ln(1+3D^{1/2}/A) (3),

where αm is an offset coefficient. Thus, when the offset is calculated using the equation (3) with respect to the operation mode m=1 and α1=0.32, Thoffset1 (i.e., the desired quality threshold to which the calculated offset is added) is given by: Thoffset1=6.27 dB.

When the offset is calculated using the equation (3) with respect to the operation mode m=2 and α2=0.37, Thoffset2 (i.e., the desired quality threshold to which the calculated offset is added) is given by: Thoffset2=13.31 dB.

Furthermore, when the offset is calculated using the equation (3) with respect to the operation mode m=3 and α3=0.63, Thoffset3 (i.e., the desired quality threshold to which the calculated offset is added) is given by: Thoffset3=28.54 dB.

If the desired quality threshold Thoffset for any of the operation mode is equal to or less than the reception quality measurement value Z, the relevant operation mode is applicable. Meanwhile, if the desired quality threshold Thoffset for any of the operation mode is greater than the reception quality measurement value Z, the relevant operation mode is not applicable.

In this example, Z=28 dB, where Z is a CINR value that is a reception quality measurement value. In the operation mode m=1, the desired quality threshold Thoffset1 is given by: Thoffset1=6.27 dB. Accordingly, Z≧Thoffset1 (i.e., 28 dB≧6.27 dB), and thus the operation mode m=1 is applicable.

In the operation mode m=2, the desired quality threshold Thoffset2 is given by: Thoffset2=13.31 dB. Accordingly, Z≧Thoffset2 (i.e., 28 dB≧13.31 dB), and thus the operation mode m=2 is applicable.

Furthermore, in the operation mode m=3, the desired quality threshold Thoffset3 is given by: Thoffset3=28.54 dB. Accordingly, Z<Thoffset3 (i.e., 28 dB<28.54 dB), and thus the operation mode m=3 is not applicable.

As a result, in this example, QPSK(R=1/2) associated with the operation mode m=1 and 16QAM(R=1/2) associated with the operation mode m=2 are applicable. Therefore, 16QAM(R=1/2) with higher throughput is selected as an optimum operation mode. The selected operation mode is reported to the radio base station.

As described above, a variation in packet size is measured as dispersion, and the offset calculated from the dispersion is added to the desired qualities for individual operation modes. Then, an operation mode is selected, based on the result of comparison between the desired qualities to which the offset is added and the reception quality measurement value.

This makes it possible to select an optimum operation mode based on the result of appropriately estimating the number of FEC code blocks contained in one packet, and in turn to suppress deterioration of throughput.

When packet sizes are averaged over a plurality of frames, there may be a case in which an allocated amount significantly varies. In such a case, it is very likely that the desired quality is estimated to be low, so that the packet error rate increases when a packet size is much more than the average. However, this situation can be prevented by measuring the packet size dispersion and increasing the desired quality according to this dispersion as described above.

Next, the detailed configuration of the radio communication apparatus will be described below. The following describes an example in which an orthogonal frequency division multiplexing (OFDM) communication system is employed for communications between a radio base station and a radio communication apparatus. However, other communication systems such as a single carrier communication system may be employed therefor.

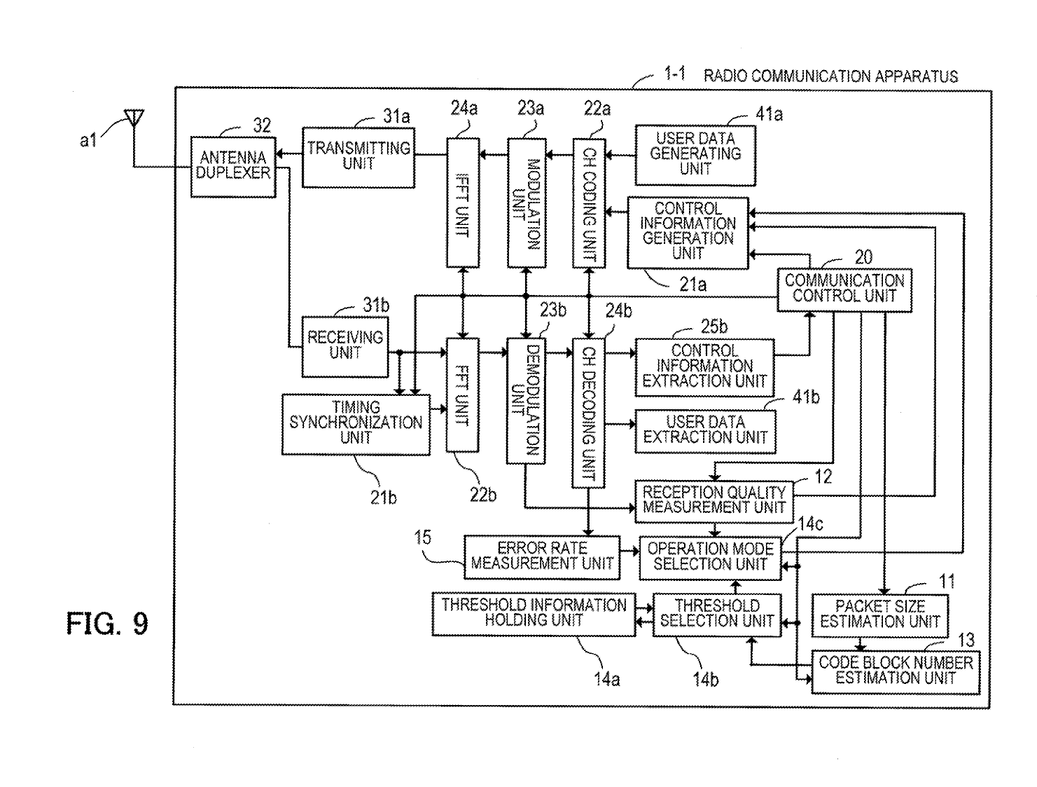

FIG. 9 illustrates a configuration example of a radio communication system. Regarding the configuration of the radio communication apparatus 1-1, as components related to application processing of user data and the like, the radio communication apparatus 1-1 includes a user data generation unit 41a and a user data extraction unit 41b.

Furthermore, as components related to baseband processing, the radio communication apparatus 1-1 includes a communication control unit 20, a control information generation unit 21a, a channel (CH) coding unit 22a, a modulation unit 23a, an Inverse FFT (IFFT) unit 24a, a timing synchronization unit 21b, a fast Fourier transform (FFT) unit 22b, a demodulation unit 23b, a CH decoding unit 24b, and a control information extraction unit 25b.

Furthermore, as components related to communication facility, the radio communication apparatus 1-1 includes a transmitting unit 31a, a receiving unit 31b, an antenna duplexer 32, and an antenna a1.

Furthermore, as components related to operation mode selection control, the radio communication apparatus 1-1 includes a packet size estimation unit 11, a reception quality measurement unit 12, a code block number estimation unit 13, a threshold information holding unit 14a, a threshold selection unit 14b, an operation mode selection unit 14c, and an error rate measurement unit 15.

Operations of the above components will be described below. The user data generation unit 41a generates traffic data according to user's intended communication. The control information generation unit 21a generates control information to be supplied to a destination.

The CH coding unit 22a performs error correction coding, interleaving, and the like, using the traffic data and the control information in combination. The modulation unit 23a performs bit repetition of encoded data, insertion of a pilot signal or a preamble signal, modulation with QPSK, QAM, or the like, thereby allocating modulation signals to respective subcarrier symbols of the OFDM system.

The IFFT unit 24a inversely Fourier transforms symbols allocated to the subcarriers for conversion to a time waveform (also performs guard interval insertion).

The transmitting unit 31a includes a local frequency oscillator, a digital to analog (DA) converter, a mixer, a transmission power amplifier, a filter, and the like (not illustrated). The transmitting unit 31a performs frequency conversion, amplification, and waveform shaping, so that a digital baseband signal is upconverted to a transmission radio frequency (RF) signal.

The antenna duplexer 32 switches between transmission signals and reception signals on a frequency-by-frequency hour-by-hour basis, in order to use the antenna a1 that is common to transmission and reception (i.e., bidirectional antenna). The transmission RF signal that passed through the antenna duplexer 32 is transmitted from the bidirectional antenna a1. Meanwhile, signals received by the bidirectional antenna a1 are separated from transmission signals by the antenna duplexer 32, and supplied to the receiving unit 31b.

The receiving unit 31b includes a local frequency oscillator, a band limiting filter, a receiving low noise amplifier, a quadrature demodulator, an automatic gain control amplifier (AGC), an analog to digital (AD) converter, and the like. The receiving unit converts a received RF signal to a digital baseband signal.

The timing synchronization unit 21b detects radio frame timing and symbol synchronization timing of a received signal, and notifies the FFT unit 22b of FFT window start timing.

The FFT unit 22b sets an FFT window at a designated timing, and Fourier transforms an input sample string into received subcarrier symbols in frequency domain.

The demodulation unit 23b performs propagation path estimation, demodulation and the like using the known pilot signal or preamble signal which has been inserted in the subcarrier, and takes out a received encoded symbol string. The CH decoding unit 24b extracts a received data string by performing decoding associated with the encoding that was performed at a time of transmission, and performing error correction and detection.

The control information extraction unit 25b extracts control information to be used for communication control from the received data, and transfers the control information to the communication control unit 20.

The user data extraction unit 41b extracts data to be used for user's communications from the received data. The communication control unit 20 controls operations of the associated respective units according to instructions from upper layer functions, control information extracted from the received data, and the like.

The reception quality measurement unit 12 measures a received signal quality represented by CINR or the like using the known signals (such as a pilot signal, preamble signal, and the like) detected by the demodulation unit 23b, and transfers the measurement result to the control information generation unit 21a and the operation mode selection unit 14c.

The error rate measurement unit 15 measures a packet error rate based on the result of detecting errors in the received packet from the CH decoding unit 24b. Then, the error rate measurement unit 15 notifies the operation mode selection unit 14c of the measurement result to instruct the operation mode selection unit 14c to modify a selection criterion when any inappropriate operation mode is selected.

The operation mode selection unit 14c performs operation mode selection to select an operation mode such as MCS, MIMO or the like, according to the instruction from the communication control unit 20. Then, the operation mode selection unit 14c notifies the control information generation unit 21a of the selection result.

The threshold selection unit 14b selects a desired quality threshold to be used for selecting an operation mode, and notifies the operation mode selection unit 14c of the selection result. The threshold information holding unit 14a holds desired quality thresholds for individual operation modes or for the individual numbers of code block in a form of table or computational expression.

The packet size estimation unit 11 estimates a size allocated to one packet for the radio communication apparatus 1-1. The code block number estimation unit 13 calculates the numbers of code blocks contained in one packet based on the code block sizes for individual operation modes.

The code block sizes for individual operation modes which are used at this time are the maximum values which are determined with respect to the individual communication systems. It is usual to select a code block size as great as possible with respect to a data size in order to enhance an error correction effect. Therefore, it is reasonable to use its maximum value.

Next, operation mode selection control of the embodiment will be described below. The communication control unit 20 selects packet allocation information on the radio communication apparatus 1-1 from the control information extracted by the control information extraction unit 25b, and notifies the packet size estimation unit 11 of the selected information.

Based on this packet allocation information, the packet size estimation unit 11 estimates communicating packet sizes of possible operation modes. Each packet size is determined by averaging sizes allocated to one packet over a plurality of past frames. Arithmetic averaging, moving averaging, exponential averaging, and the like may be used as the averaging.

When the communication control unit 20 decides to perform operation mode selection, the operation mode selection unit 14c, threshold selection unit 14b, and code block number estimation unit 13 are notified of start of the selection operation and the type of operation to be started (MCS selection, MIMO mode selection, etc.).

The code block number estimation unit 13 calculates the numbers of code blocks with respect to the individual operation modes to be selected from the packet size estimation result and the code block size. The threshold selection unit 14b selects desired quality thresholds with respect to the individual operation modes from the contents held in the threshold information holding unit 14a by use of corresponding numbers of code blocks, and notifies the operation mode selection unit 14c of the selection result.

Based on comparison between the supplied desired quality thresholds for individual operation modes and the reception quality measurement value, the operation mode selection unit 14c determines whether the individual operation modes are applicable. Furthermore, among the applicable operation modes, the operation mode selection unit 14c selects an operation mode that satisfies the selection criterion (for example, selecting an operation mode that provides the maximum throughput), and generates a report value corresponding to the selected operation mode.

Thus, the operation mode selection unit 14c is able to select an operation mode using the desired quality threshold based on the numbers of code blocks for individual operation modes contained in one packet. Therefore, compared with a conventional case of selecting an operation mode based on estimating the fixed number of code blocks, selection of an operation mode with a packet error rate being closer to a target packet error rate is realized.

For example, when a criterion for selecting an operation mode based on a measurement of the packet error rate is modified, averaging to determine a reasonable error rate has to be done to detect whether the modification is desired. For a propagation path of an International Telecommunication Union-Radio communication Sector (ITU-R) Pedestrian B (3 km/h) channel model that is employed for the Mobile WiMAX standard, in order to average the fading fluctuations in the propagation path, averaging for at least 20 frames has to be performed.

In the case where the number of code blocks in one packet is different from an estimated number, the error rate therebetween increases or is too low. As a result, an optimum throughput may not be obtained. If a reduced number of the frames is used for averaging error rate measurements and the selection criterion is modified based on instantaneous packet error detection, fluctuations in propagation paths and control delay of operation mode selection could make a convergence of selection criteria unstable.

On the other hand, the packet allocation information is information that has been established and contained in control information (MAP information). Furthermore, a packet size is determined depending on the operating states of communication applications and the degree of network congestion, and so the size is considered to be maintained at a constant or near-constant state during a certain period.

In this way, the radio communication apparatus 1-1 converges the packet size estimation to a reasonable value in a short period, so as to make a communication error rate after selection of operation mode closer to a target value.

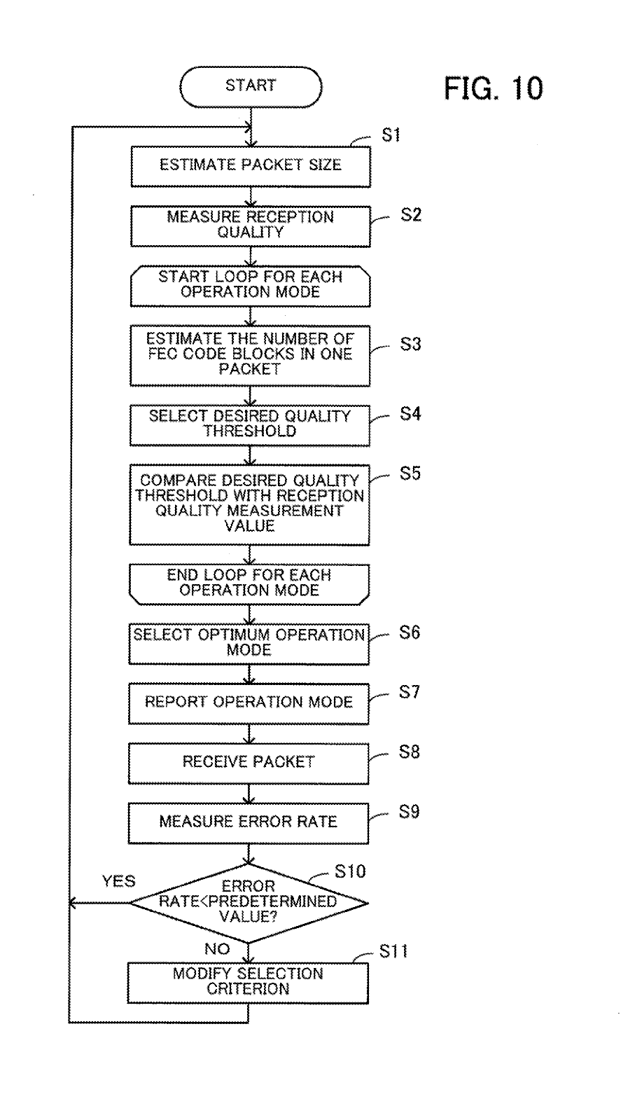

Next, the operations will be described using a flowchart. FIG. 10 illustrates an operation flow.

[S1] The packet size estimation unit 11 estimates a size of one packet transmitted to its own radio communication apparatus.

[S2] The reception quality measurement unit 12 receives preamble signals and pilot signals from a radio base station, and measures reception quality represented by CINR or the like.

[S3] The code block number estimation unit 13 estimates the numbers of FEC code blocks contained in one packet using the estimated packet size and the FEC code block sizes with respect to the individual operation modes.

[S4] The threshold selection unit 14b selects desired quality thresholds with respect to the individual operation modes, for example, from a threshold information table T2 using the corresponding estimated numbers of FEC code blocks.

[S5] The operation mode selection unit 14c recognizes desired quality thresholds for individual operation modes based on the estimated numbers of FEC code blocks, and compares the desired quality thresholds with the reception quality measurement value.

[S6] The operation mode selection unit 14c selects an optimum operation mode based on the comparison result.

[S7] The operation mode selection unit 14c notifies the control information generation unit 21a of the selected operation mode. The control information generation unit 21a generates control information containing the selected operation mode. This control information is upconverted, and then transmitted to the radio base station side through the antenna a1.

When the radio base station recognizes the operation mode selected by the radio communication apparatus 1-1, the radio base station sets up this operation mode, and performs data transmission using the operation mode selected by the radio communication apparatus 1-1.

[S8] The radio communication apparatus 1-1 receives packets transmitted from the radio base station.

[S9] The error rate measurement unit 15 measures an error rate of the received packets, and notifies the operation mode selection unit 14c of the measurement result.

[S10] The operation mode selection unit 14c determines whether the packet error rate is equal to or less than a predetermined value. If the packet error rate is equal to or less than the predetermined value, the process returns to step S1. If the packet error rate is greater than the predetermined value, the process goes to step S11.

[S11] The operation mode selection unit 14c modifies the selection criterion associated with selection of the operation mode, and the process returns to step S1. The selection criterion is modified, for example, by selecting other desired quality thresholds from threshold information table T2-1 illustrated in FIG. 6.

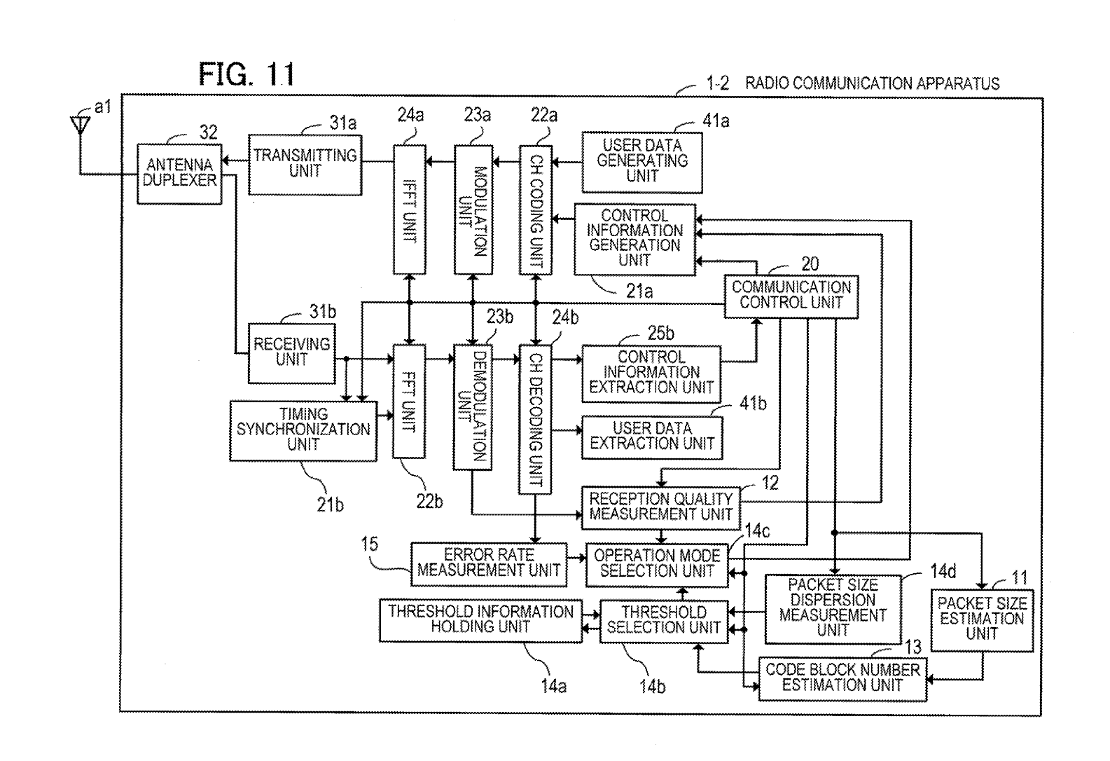

Next, a detailed configuration of a radio communication apparatus that performs packet dispersion measurement will be described below. FIG. 11 illustrates a configuration example of a radio communication apparatus. The radio communication apparatus 1-2 has a configuration in which a packet size dispersion measurement unit 14d is newly added to the configuration illustrated in FIG. 9 described above. Except for this, the configurations of the two are the same. Thus, the description will be given only on the packet size dispersion measurement unit 14d.

Using packet allocation information supplied from a communication control unit 20, the packet size dispersion measurement unit 14d measures a variation in allocated size to one packet as dispersion. The magnitude of the fluctuation causes uncertainty of a result of calculating the number of code blocks to be used for determining a desired quality threshold.

The low estimated number of code blocks results in an increase in error rate. This raises the risk of substantially deteriorating throughput. Thus, a margin is added to a desired quality threshold according to the magnitude of the fluctuation, so that an increase in error rate is not caused by selection of an operation mode.

In addition, this margin may be realized by adding a margin to a calculated value regarding the number of code blocks, based on the relationship between the number of code blocks and the desired quality.

Measuring a variation in allocated size to one packet as dispersion enables selection of an operation mode while preventing an increase in error rate that is caused by estimation error in the number of code blocks when a packet allocation state undergoes significant change.

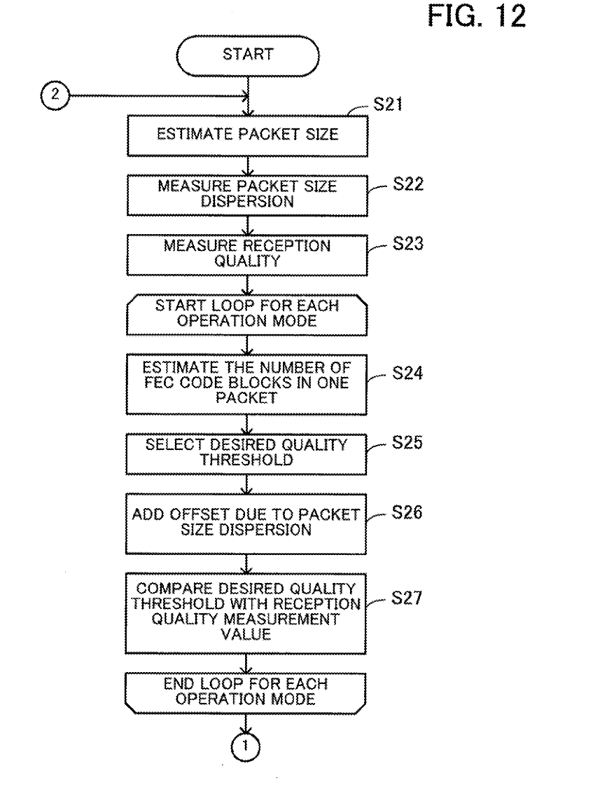

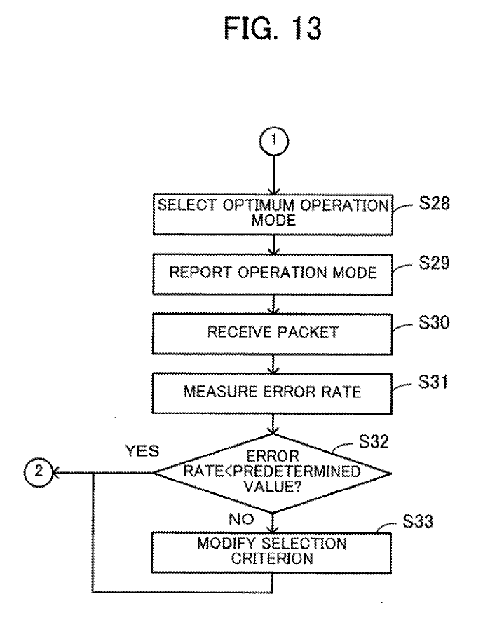

Next, the operations will be described using a flowchart. FIGS. 12 and 13 illustrate an operation flow.

[S21] A packet size estimation unit 11 estimates the size of one packet transmitted to its own radio communication apparatus.

[S22] The packet size dispersion measurement unit 14d measures packet size dispersion.

[S23] A reception quality measurement unit 12 receives preamble signals and pilot signals from a radio base station, and measures reception quality represented by CINR or the like.

[S24] A code block number estimation unit 13 estimates the numbers of FEC code blocks contained in one packet using the estimated packet size and the FEC code block sizes for individual operation modes.

[S25] A threshold selection unit 14b selects desired quality thresholds with respect to the individual operation modes, for example, from a threshold information table T2 using the corresponding estimated number of FEC code blocks.

[S26] An operation mode selection unit 14c adds an offset due to the packet size dispersion to the desired quality thresholds which are recognized based on the estimated numbers of FEC code blocks.

[S27] The operation mode selection unit 14c compares the desired quality thresholds with the reception quality measurement value.

[S28] The operation mode selection unit 14c selects an optimum operation mode based on the comparison result.

[S29] The operation mode selection unit 14c notifies a control information generation unit 21a of the selected operation mode. The control information generation unit 21a generates control information containing the selected operation mode. The control information is upconverted, and then transmitted to the radio base station side through the antenna a1.

When the radio base station recognizes the operation mode selected by the radio communication apparatus 1-2, the radio base station sets up this operation mode, and performs data transmission using the operation mode selected by the radio communication apparatus 1-2.

[S30] The radio communication apparatus 1-2 receives packets transmitted from the radio base station.

[S31] An error rate measurement unit 15 measures an error rate of the received packets, and notifies the operation mode selection unit 14c of the measurement result.

[S32] The operation mode selection unit 14c determines whether the packet error rate is equal to or less than a predetermined value. If the packet error rate is equal to or less than the predetermined value, the process returns to step S21. If the packet error rate is greater than the predetermined value, the process goes to step S33.

[S33] The operation mode selection unit 14c modifies selection criterion associated with selection of the operation mode, and the process returns to step S21. The selection criterion is modified, for example, by selecting other desired quality thresholds from threshold information table T2-1 illustrated in FIG. 6.

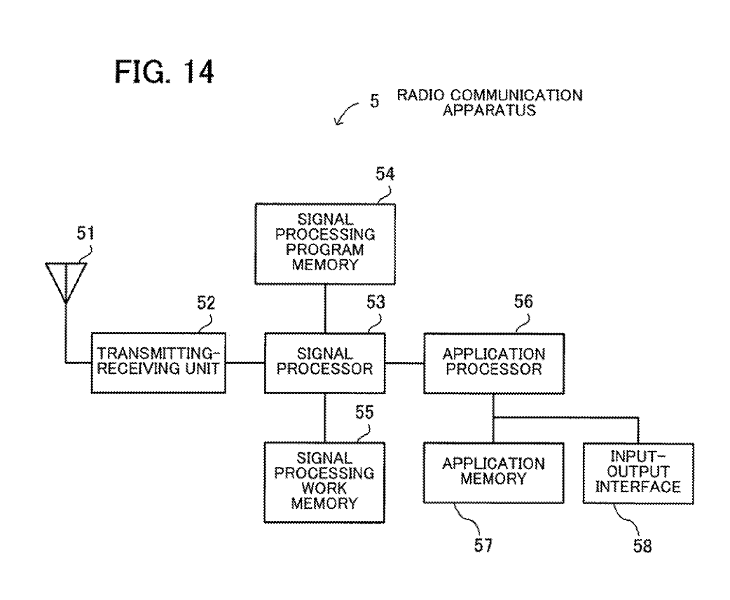

Next, a hardware configuration of the radio communication apparatus will be described below. FIG. 14 illustrates a hardware configuration example of the radio communication system. A radio communication apparatus 5 includes a bidirectional antenna 51, a transmitting-receiving unit 52, a signal processor 53, a signal processing program memory 54, a signal processing work memory 55, an application processor 56, an application memory 57, and an input-output interface unit 58.

For example, the radio communication apparatus 5 is different from the radio communication apparatus 1-2 of FIG. 11 in the following points.

Regarding application processing of user data and the like, the radio communication apparatus 5 substitutes the application processor 56, application memory 57, and input-output interface unit 58, for the user data generation unit 41a and user data extraction unit 41b.

Furthermore, regarding baseband processing, the radio communication apparatus 5 substitutes the signal processor 53, signal processing work memory 55, signal processing program memory 54, and the programs stored therein, for the communication control unit 20, control information generation unit 21a, CH coding unit 22a, modulation unit 23a, IFFT unit 24a, timing synchronization unit 21b, FFT unit 22b, demodulation unit 23b, CH decoding unit 24b, and control information extraction unit 25b.

Furthermore, regarding the transmission and receiving function, the radio communication apparatus 5 substitutes the antenna 51 and transmitting-receiving unit 52, for the transmitting unit 31a, receiving unit 31b, antenna duplexer 32, and antenna a1.

Furthermore, regarding the operation mode selection control, the radio communication apparatus 5 is different from the radio communication apparatus 1-2 in that the packet size estimation unit 11, reception quality measurement unit 12, code block number estimation unit 13, threshold information holding unit 14a, threshold selection unit 14b, operation mode selection unit 14c, packet size dispersion measurement unit 14d, and error rate measurement unit 15, are implemented in the signal processing programs. These signal processing programs are stored in the signal processing program memory 54 and executed by the signal processor 53.

A desired quality threshold table and an equation for deriving offset are stored in the signal processing program memory 54. Furthermore, baseband signal processing may be partly executed by dedicated hardware such as an LSI and the like.

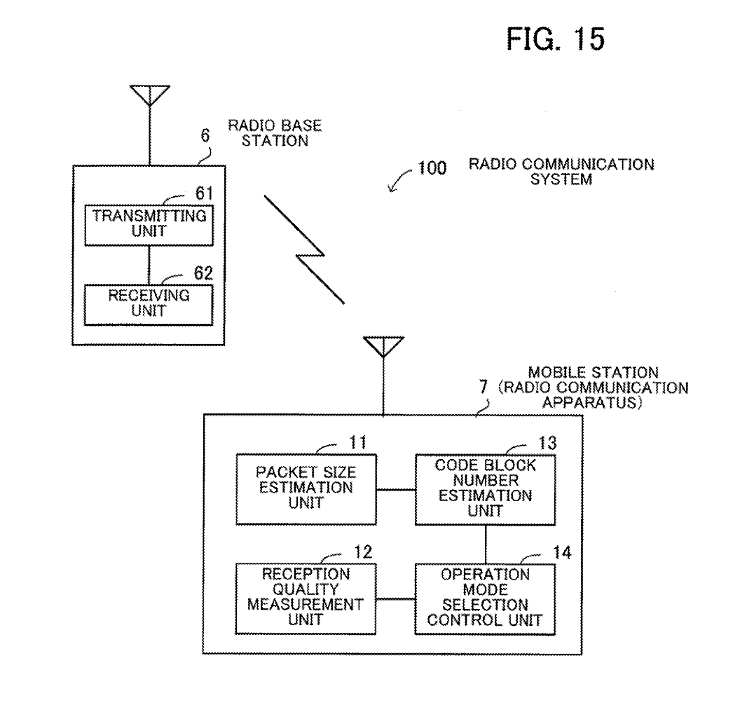

Next, a radio communication system will be described below. FIG. 15 illustrates a configuration example of the radio communication system. The radio communication system 100 includes a radio base station 6 and a mobile station 7 (corresponding to the radio communication apparatus 10). The radio base station 6 includes a transmitting unit 61 and a receiving unit 62. The mobile station 7 has the same configuration as that of the radio communication apparatus 10. Since the operations of the mobile station 7 are the same as those of the radio communication apparatus 10 explained earlier, no further description will be given here.

The transmitting unit 61 transmits control information such as MAP information and the like, and preamble signals (pilot signals) to the mobile station 7. The receiving unit 62 receives a report of an operation mode selected by the mobile station 7.

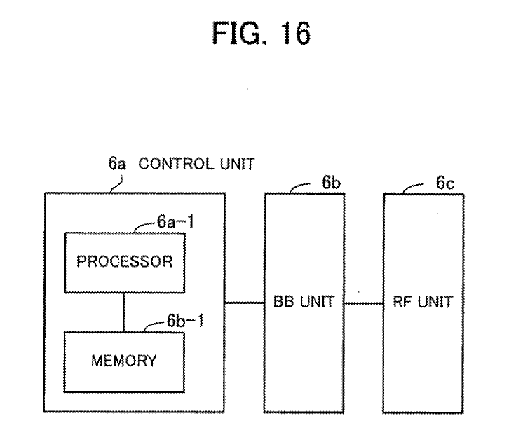

FIG. 16 illustrates a configuration example of the radio communication system. The radio base station 6 includes a control unit 6a, a base band (BB) unit 6b, and an RF unit 6c. The control unit 6a includes a processor 6a-1, and a memory 6b-1.

The processor 6a-1 executes control relating to transmitting and receiving operations of the radio base station 6. The memory 6b-1 stores information desired for management of operations. The BB unit 6b modulates baseband signals when data is transmitted by the transmitting unit 61. The BB unit 6b also demodulates baseband signals when data is received by the receiving unit 62.

The RF unit 6c performs a radio interface process. For example, the RF unit 6c performs up-conversion for converting a baseband bandwidth to a radio frequency bandwidth when data is transmitted by the transmitting unit 61. Furthermore, the RF unit 6c performs down-conversion for converting a radio frequency bandwidth to a baseband bandwidth when data is received by the receiving unit 62.

As described above, the radio communication apparatus 10 estimates the size of a packet transmitted from the transmission side to the own apparatus based on the past allocation states, and further estimates the numbers of error correction code blocks contained in one packet when individual possible operation modes are used.

Then, based on the estimated numbers of error correction code blocks, the radio communication apparatus 10 estimates desired qualities which are desirable for individual operation modes to be selected. Subsequently, the radio communication apparatus 10 compares the desired qualities with the reception quality measurement value, and selects an operation mode that is suitable for a propagation environment based on the comparison result.

In this way, even when the number of error correction code blocks contained in one packet varies, the radio communication apparatus 10 corresponding to a mobile station is able to appropriately estimate the number of error correction blocks, and in turn to select an optimum operation mode.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A radio communication apparatus comprising:
a packet size estimation unit configured to estimate a packet size of a packet transmitted to the radio communication apparatus;
a reception quality measurement unit configured to perform reception quality measurement of a received signal to obtain a reception quality measurement value;
a code block number estimation unit configured to estimate numbers of code blocks contained in the packet using the packet size and code block sizes for individual operation modes; and
an operation mode selection control unit configured to recognize desired qualities for the individual operation modes based on the estimated numbers of code blocks, and select an operation mode based on a result of comparing the desired qualities with the reception quality measurement value.

2. The radio communication apparatus according to claim 1, further comprising:
a packet size dispersion measurement unit configured to measure a variation in the packet size as dispersion,
wherein the operation mode selection control unit adds an offset calculated based on the dispersion to the desired qualities for the individual operation modes, and selects an operation mode based on a results of comparing the desired qualities to which the offset is added with the reception quality measurement value.

3. The radio communication apparatus according to claim 1, wherein the operation mode selection control unit holds the desired qualities for the individual operation modes corresponding to the numbers of code blocks contained in the packet.

4. The radio communication apparatus according to claim 1, wherein the operation mode selection control unit calculates the desired qualities for the individual operation modes using an approximation expression by a logarithmic function of the numbers of code blocks.

5. A radio communication method executed by a radio communication apparatus, comprising:
estimating a packet size of a packet transmitted to the radio communication apparatus;
performing reception quality measurement of a received signal to obtain a reception quality measurement value;
estimating numbers of code blocks contained in the packet using the packet size and code block sizes for individual operation modes; and
recognizing desired qualities for the individual operation modes based on the estimated numbers of code blocks, and selecting an operation mode to establish radio communications, based on a result of comparing the desired qualities with the reception quality measurement value.

6. A radio communication system comprising:
a radio base station; and
a mobile station,
wherein the mobile station includes:
a packet size estimation unit configured to estimate a packet size of a packet transmitted to the mobile station from the radio base station;
a reception quality measurement unit configured to perform reception quality measurement of a received signal to obtain a reception quality measurement value;
a code block number estimation unit configured to estimate numbers of code blocks contained in the packet using the packet size and code block sizes for individual operation modes; and
an operation mode selection control unit configured to recognize desired qualities for the individual operation modes based on the estimated numbers of code blocks, and select an operation mode based on a result of comparing the desired qualities with the reception quality measurement
